(19) United States
(12) Patent Application Publication
(10) Pub. No.: US 2015/0063914 A1
(43) Pub. Date: Mar. 5, 2015

(54) METHODS AND APPARATUS FOR ARRESTING FAILURES IN SUBMERGED PIPELINES

(71) Applicant: Halliburton Energy Services, Inc., Houston, TX (US)

(72) Inventors: Steven Ray Lovett, Marlow, OK (US); Aimee Kathleen Greening, Duncan, OK (US)

(73) Assignee: Halliburton Energy Services, Inc, Houston, TX (US)

(21) Appl. No.: 14/014,769

(22) Filed: Aug. 30, 2013

(51) Int. Cl. F16L 1/12

(52) U.S. Cl. CPC F16L 1/123
USPC 405/158

(57) ABSTRACT

A packer apparatus includes a spindle including a pressure plate disposed adjacent a first end of the packer apparatus, a first end cap defining the second end of the packer apparatus; a seal plate disposed between the pressure plate and the first end cap; a mandrel and a brake disposed between the pressure and seal plates, and an elastomeric expansion boot disposed between the seal plate and the first end cap. The mandrel includes a tapered outer surface and the brake includes a tapered inner surface abutting the tapered inner surface of the mandrel. The pressure plate is configured to be actuated by fluid pressure within the pipeline to move the spindle axially toward the first end cap from a first position to a second position to cause the expansion boot and the brake to engage an inner surface of the pipeline.

### BACKGROUND

This disclosure relates generally to offshore pipelines, and more specifically to methods and apparatus for responding to failures in offshore submerged pipelines.

In offshore pipeline installations, as the pipeline is laid on the sea floor the pipeline is subjected to significant forces and moments that can compromise the integrity of the pipeline and, in some cases, cause failures. In the event the submerged pipeline is compromised to the point of failure, water rushes into the pipeline. Such failures are commonly referred to as wet buckles. Once a wet buckle occurs the flooded pipeline is too heavy to retrieve for repair and re-installation.

Companies that lay the pipeline keep a fleet of compressor ships on standby while the pipeline is being laid on the sea floor in case of a failure like a wet buckle. The compressor ships are present to pump the water out of the pipeline to facilitate repair of the buckled section, by allowing the pipeline to be pulled back to the surface, to the pipelay vessel, for removal of the damaged section. After the water has been removed, sections of the damaged pipeline can be retrieved and brought to the surface and the pipelay vessel can continue laying pipe onto the sea floor.

Pipeline failures like wet buckles are relatively rare. As such, during installation, the fleet of compressor ships hired by the pipeline installation company is generally inactive and serves no function for the installation process unless the rare failure occurs. The cost of the compressor ships and the associated service the ships and crew provide can reach the millions of dollars.

### BRIEF DESCRIPTION OF DRAWINGS

FIG. 1 schematically depicts a submerged pipeline installation system including wet buckle packers in accordance with this disclosure.

FIG. 2 depicts an elevation view of an example wet buckle packer.

FIG. 3 depicts an exploded view of different components of the packer of FIG. 2.

FIG. 4A depicts a section view of the example packer of FIG. 2 in an unengaged state within a pipeline.

FIG. 4B depicts a section view of the example packer of FIG. 2 in an engaged state within a pipeline.

FIG. 5 depicts an example method of arresting a failure in a submerged pipeline.

### DETAILED DESCRIPTION

In view of the foregoing costs and other inefficiencies associated with recovering from an offshore pipeline failure, examples according to this disclosure are directed to methods and apparatus for automatically responding to water invasion into the inner diameter of pipe in an offshore pipeline and rapidly deploying a sealing system that will prevent or inhibit the laid pipeline from being flooded with water.

A packer apparatus in accordance with this disclosure is configured to be arranged within and arrest a failure of a submerged pipeline. In one example, the packer apparatus includes a spindle, a first end cap, a seal plate, a mandrel, a brake, and an elastomeric expansion boot. The spindle includes a pressure plate disposed adjacent a first end of the packer apparatus. The first end cap defines the second end of the packer apparatus. The seal plate is disposed between the pressure plate and the first end cap. The mandrel and brake are disposed between the pressure and seal plates. The mandrel includes a tapered outer surface and the brake includes a tapered inner surface abutting the tapered inner surface of the mandrel. The expansion boot is disposed between the seal plate and the first end cap. The pressure plate is configured to be actuated by fluid pressure within the pipeline to move the spindle axially toward the first end cap from a first position to a second position. In the second position, the spindle causes: the expansion boot to compress axially between the seal plate and the first end cap and expand radially into engagement with an inner surface of the pipeline; and the tapered inner surface of the brake to move axially along the tapered outer surface of the mandrel to cause the brake to move radially outward into engagement with the inner surface of the pipeline.

In the following examples, the apparatus for arresting pipeline wet buckles (and other pipeline failures) is referred to as a wet buckle packer. However, the apparatus could also be referred to as a plug, a shutoff pig, a baffle, or other terms connoting a device that restricts, and ideally prevents fluid flow through an annular pipeline.

Wet buckle packers in accordance with this disclosure provide a number of functions once actuated. Packer apparatus in accordance with this disclosure are sometimes referred to as configured to arrest a failure like a wet buckle in a submerged pipeline. Arresting a failure in a pipeline includes a number of different functions. In both dry and wet buckles, for example, the pipeline failure can include a structural failure including a buckle that causes the pipeline to at least partially collapse on itself. The structural buckle can run along the length of the pipeline unless it is arrested. In wet buckles, water also invades the inner diameter of the pipe causing the pipeline to become flooded. Packer apparatus in accordance with this disclosure can function to arrest both a structural buckle in a submerged pipeline, whether from a dry or wet buckle, and deploy a sealing system that will prevent or inhibit the laid pipeline from being flooded with water in the event of a wet buckle. Additionally, the packer deploys a braking mechanism to prevent or inhibit the packer from moving within the pipeline under the significant pressures introduced by the sea (or fresh) water entering the pipe from the wet buckle.

As noted above, wet buckle packers in accordance with this disclosure are configured to be automatically actuated to seal the pipeline inner diameter from ingress of water. The mechanisms for sealing and braking employed in a wet buckle packer can be actuated in a variety of ways. For example, electrical, hydraulic, or pneumatic supply lines can be run from the pipelay vessel on the surface to the packer. However, deploying supply lines from the surface downpipe to the packer will add cost and complexity to the system. The wet buckle packer could also include a power source, e.g., a battery that could be used to actuate the seal and brake mechanisms. However, the inclusion of a battery or other power source to actuate the packer will add cost and complexity to the device. In some cases, therefore, wet buckle packers are believed to be better configured to automatically actuate without the use of a power source or external actuation generator like a supply line run downpipe from the surface. As a result, while power sources or external actuation may be used in association with wet buckle packers as described herein, the examples of this disclosure are in accordance with what is believed to be the better configuration, where no such power or external source is necessary for actuation.

Wet buckle packers in accordance with this disclosure provide a new approach to seal and anchor a packer-type plug in place within a pipeline in the event of a wet buckle. The packers are designed to provide increased durability and to include component parts that protect against external variances. Example wet buckle packers can provide a number of advantages including, e.g., removing the high cost of air compressor standby in submerged pipeline installations and providing a simple and cost effective device for arresting failures in the pipeline.

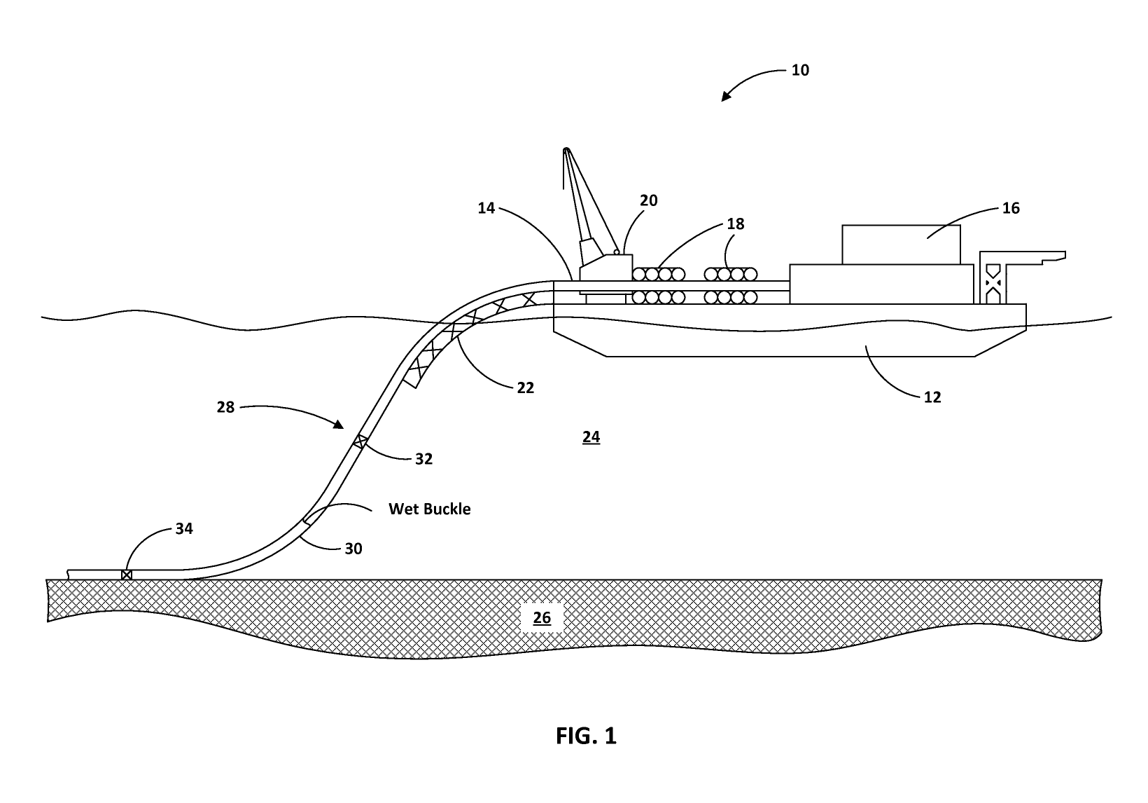

FIG. 1 depicts a submerged pipeline installation system 10. Offshore submerged pipelines can be installed in a number of ways. In general, individual pipes are transported by a cargo ship to a pipelay vessel at the pipeline installation location. The individual pipes are processed and connected to one another on the pipelay vessel and laid onto the sea floor. The pipelay vessel progressively welds individual pipes or welded pipe sections to one another to assemble the pipeline. As the pipeline is assembled the pipelay vessel moves across the surface of the water and the assembled pipeline is pulled off of the ship by the weight of the pipeline. As the pipeline is progressively pulled off of the back of the pipelay vessel it descends to the sea floor.

Two methods that are employed to install submerged pipelines are the “J” lay and the “S” lay. The moniker of each method represents the shape of the pipeline as it is pulled off of the pipelay vessel onto the sea floor. In a “J” lay, the pipeline is pulled off of the pipelay vessel substantially vertically to near the sea floor, where the pipeline bends to run horizontally along the floor. In an “S” lay, the pipeline is pulled off of the pipelay vessel substantially horizontally, bends vertically down toward the sea floor and then bends back horizontally away from the vessel to run along the sea floor. Although the following examples are described in the context of an “S” lay installation, wet buckle packers in accordance with this disclosure can also be employed in a “J” lay installation system or other pipeline installation methods not covered here.

FIG. 1 depicts a submerged pipeline installation system 10 for an “S” lay installation. In FIG. 1, system 10 includes pipelay vessel 12 and pipeline 14. Pipelay vessel 12 includes production factory 16, tensioners 18, crane 20, and stinger 22. As described in more detail below, after individual pipes are transported to and loaded on pipelay vessel 12, the pipes are conveyed into production factory 16. Production factory 16 includes a variety of processing stations for preparing pipes and coupling individual pipes into pipe sections and ultimately assembling pipeline 14, as will be known to persons skilled in the art.

Pipelay vessel 12 is shown floating in a body of water 24. Pipelay vessel 12 utilizes crane 20 to perform heavy lifting operations, including loading pipes from a cargo ship onto the vessel. In general, individual pipes on board pipelay vessel 12 are placed on an assembly line within production factory 16 and joints of the pipes are welded into pipeline 14. Pipeline 14 is held in tension between sea floor 26 and pipelay vessel 12 by pipeline tensioners 18 as the pipeline is lowered. As pipelay vessel 12 moves forward by pulling on a mooring system off of the bow, pipeline 14 is lowered from pipelay vessel 12 over stinger 22. Stinger 22 is attached to and extends from the stern of pipelay vessel 12, and provides support for pipeline 14 as it leaves pipelay vessel 12.

In practice, a cargo ship transports pipe sections (sometimes referred to as stands) to pipelay vessel 12. Crane 20 moves pipe sections from the cargo ship to pipelay vessel 12 onto cradles that form a conveyor system for moving pipe into production factory 16. Within production factory 16, a number of different operations are carried out to prepare and join pipe sections. For example, the pipe ends are beveled (and bevels are deburred). The pipe ends are preheated within production factory 16 and moved through a number of welding stations to join different sections with weld beads applied both to the outer and inner diameters of the sections at the joints. In some cases, a final welding station within production factory 16 applies a welded cap to the joints of pipe sections.

The joints of the welded pipe sections can also be tested within production factory 16. For example, the welded joints can pass through ultrasonic testing stations that apply water to the joints as the medium to transmit the ultrasonic signals. The ultrasonic signals can be processed by a computing system and graphically displayed for inspection by an operator.

After testing, the joints of the welded pipe sections can be grit blasted and a field joint coating can be applied. In some installation systems, each individual pipe is subjected to this process as it is welded to pipeline 14. In other cases, multiple pipes, e.g. two pipes in a double stand facility, are first welded together and then welded to the pipeline in the firing line onboard pipelay vessel 12. At any rate, the assembled pipeline 14 is ultimately conveyed through tensioners 18 and over stinger 22 to be dropped off of the stern of pipelay vessel 12 to sea floor 26.

As pipeline 14 is laid on sea floor 26, suspended pipe span 28 forms a shallow “S” shape between sea floor 26 and pipelay vessel 12. The “S” shape of suspended pipe 28 is sometimes referred to as the S-curve. Second curve 30 or the tail of the S-curve just before suspended pipe span 28 meets sea floor 26 is sometimes referred as the “sagbend.” The S-curve of pipeline 14 is controlled by stinger 22 and pipeline tensioners 18. Increases in the curvature of pipeline 14 cause increases in the bending moment on the pipeline, and, as a result, higher stresses. High stresses on pipeline 14 and, in particular, on suspended pipe span 28 can result in buckling of the pipeline 14. For example, a loss of tension in pipeline 14 during the pipe lay will normally cause pipeline 14 to buckle at a point along the suspended pipe span 28. A buckle in pipeline 14 is called a wet buckle if pipeline 14 has cracked or becomes damaged in a manner such that water is allowed to enter the inner diameter of the pipeline. The influx of water into the pipeline 14 greatly increases the weight of suspended pipe span 28 such that the pipe can become over stressed at a location along suspended pipe span 28, generally near stinger 22. In such circumstances, flooded pipeline 14 can break and drop from pipelay vessel 12 to sea floor 26. Regardless of whether pipeline 14 breaks in the event of a wet buckle, the increased weight can prevent recovery of and repair to pipeline 14 before the water is pumped out of the pipeline.

Examples according to this disclosure are directed to a wet buckle packer that can be deployed within the inner diameter of pipeline 14 as it is laid on sea floor 26. In FIG. 1, installation system 10 includes two wet buckle packers 32 and 34 deployed within pipeline 14. Packer 32 is deployed along suspended pipe span 28, while packer 34 is deployed downpipe where pipeline 14 meets sea floor 26. Wet buckle packers 32 and 34 are deployed within pipeline 14 with a hoist line or cable (not shown). In cases where multiple wet buckle packers are deployed in series, a hoist line may be coupled between the packers. In the example of FIG. 1, a hoist line may be coupled to a hoist on pipelay vessel 12 to packer 32 and another line can be coupled between packers 32 and 34. As will be apparent to persons skilled in the art, substantial benefits can be realized through an alternative configuration using only a single wet buckle packer, located generally in the position of depicted packer 34, positioned to prevent substantial inflow of water into the already-laid portion of pipeline 14 on sea floor 26.

Wet buckle packers 32 and 34 are configured to automatically respond to water invasion into the inner diameter of pipeline 14 and rapidly deploy a sealing system that will prevent the laid pipeline and pipeline above packer 32 from being flooded with sea water. For example, wet buckle packers 32 and 34 seal the inner diameter of pipeline 14 to prevent or significantly inhibit water from flooding the submerged pipeline. Additionally, wet buckle packers 32 and 34 deploy a braking mechanism to prevent or inhibit the packers from moving within pipeline 14 as a result of the pressures introduced by the sea water entering the pipe from the wet buckle.

In some cases one or more “piggy-back” lines may be laid from pipelay vessel 12 along with main pipeline 14. Piggy-back lines are generally constructed from smaller diameter pipes that are assembled in a similar manner as described above with reference to pipeline 14. The piggy-back lines are assembled in parallel with and are then coupled to pipeline 14, e.g., with a sleeve connected to top of the main pipeline 14 in which the piggy-back lines are received.

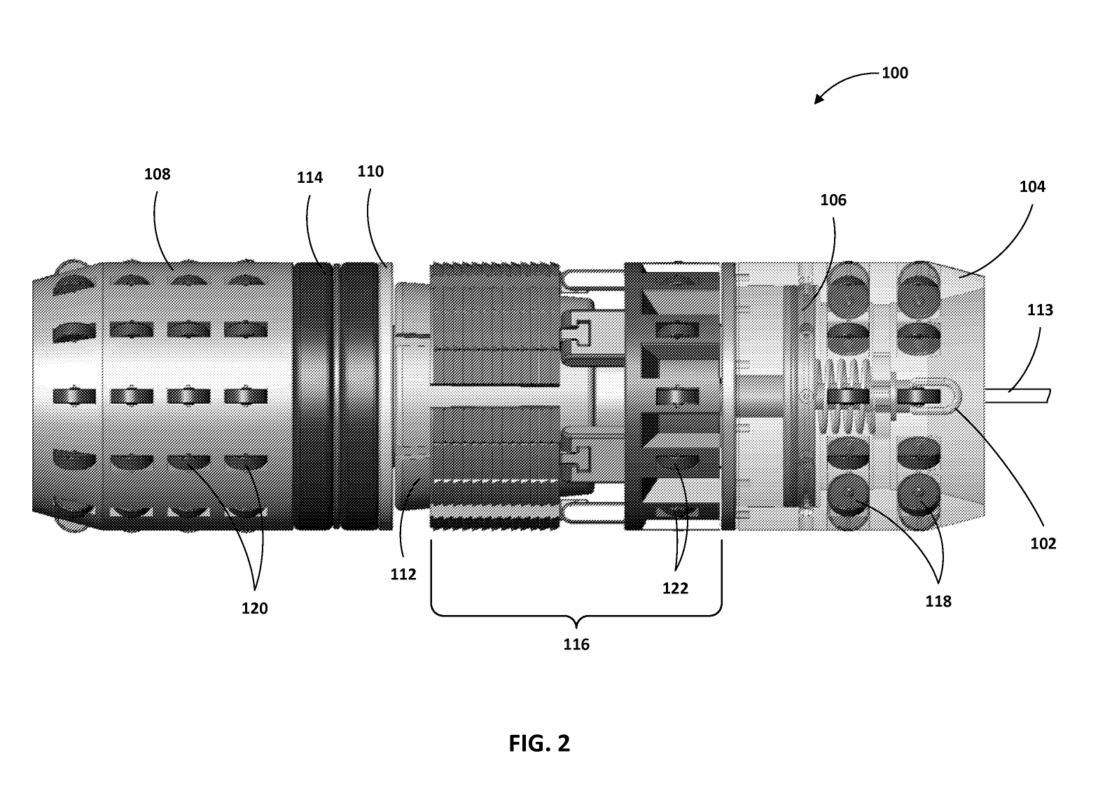

FIG. 2 depicts example wet buckle packer 100. Packer 100 includes a hoist ring 102, a perforated end cap 104, a spindle 106, a base cap 108, a seal plate 110, a packer mandrel 112, an elastomeric expansion boot 114, and a brake assembly 116. Packer 100 is coupled to hoist line 113 by hoist ring 102, which is connected to cap 104.

Packer 100 is configured to be deployed from a pipelay vessel down a submerged pipeline via hoist line 113. Packer 100 can be lowered into an already submerged pipeline or can be lowered along with a particular section of the pipeline as it is dropped to the sea floor. The generally cylindrical shape of packer 100 defined by the outer peripheries of end cap 104, spindle 106, base cap 108, seal plate 110, elastomeric expansion boot 114, and brake assembly 116 are configured to slide within the pipeline as packer 100 is deployed downpipe from the pipeline vessel. Additionally, end cap 104, base cap 108, and brake assembly 116 each include a number of freely rotating wheels 118, 120, and 122, respectively, which are distributed around the outer circumference of each of the components. Wheels 118, 120, and 122 facilitate travel of packer 100 through the submerged pipeline as packer 100 is lowered from the pipelay vessel and as otherwise may be needed during the pipe laying process.

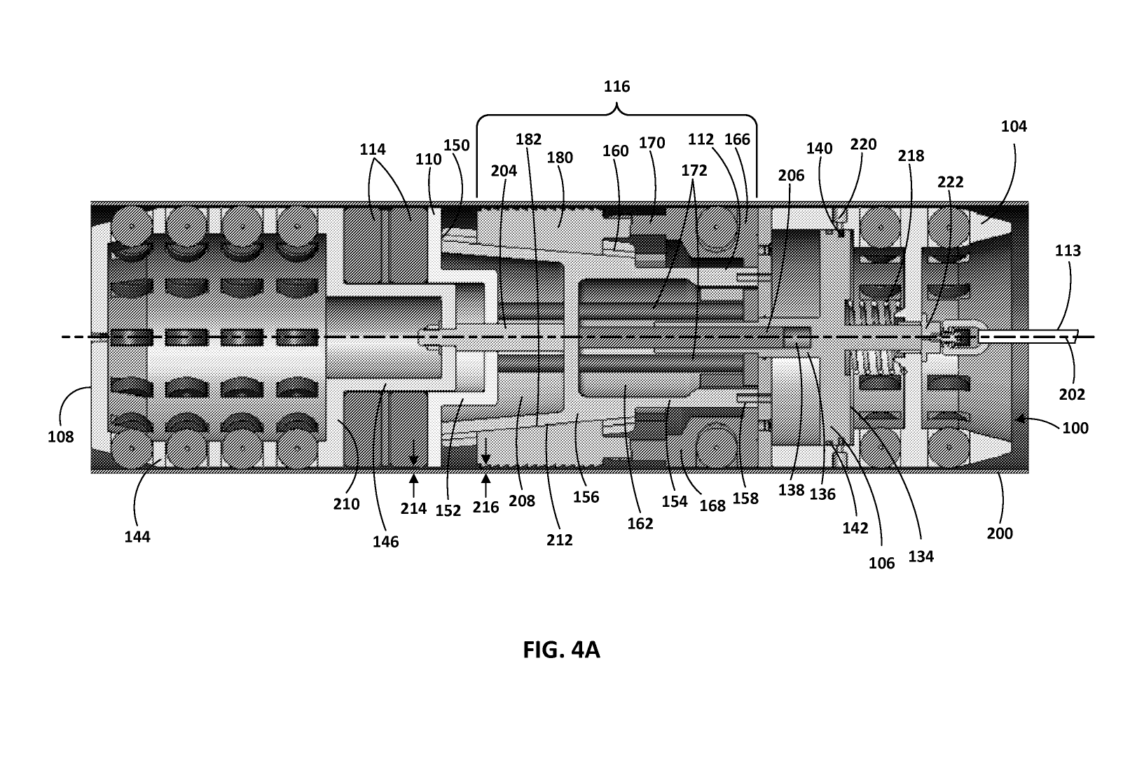

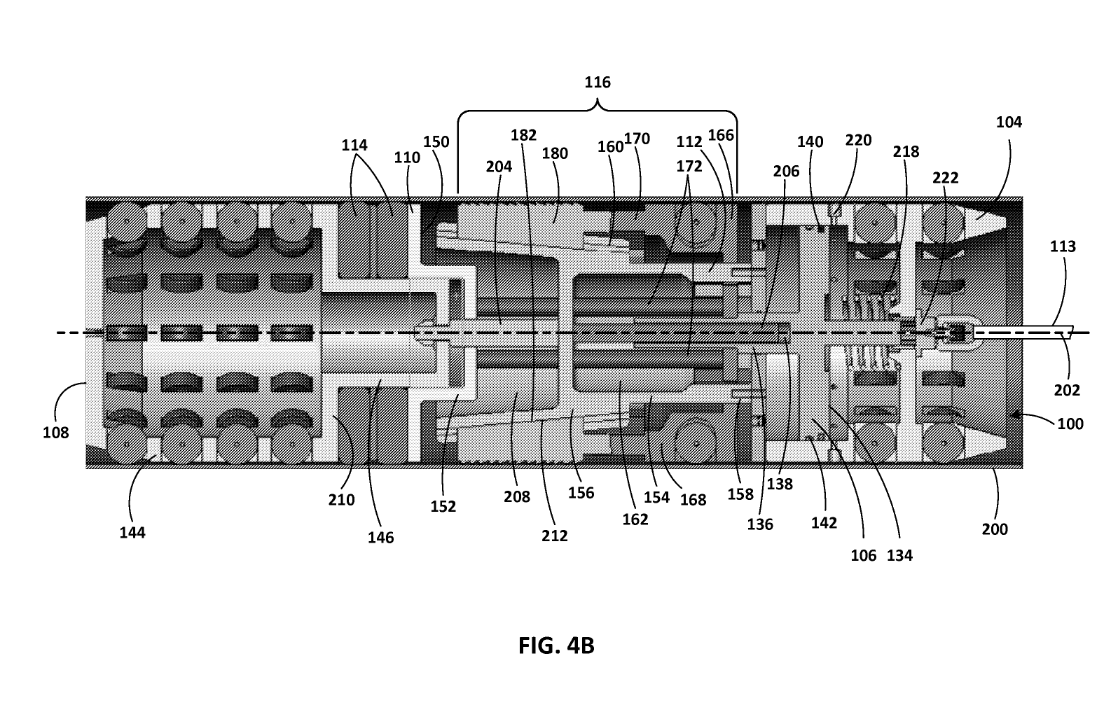

Packer 100 can be deployed at a number of locations within the submerged pipeline to arrest pipeline failures like wet buckles. For example, packer 100 can be deployed along a suspended pipe span of the pipeline or further downpipe where the pipeline meets the sea floor. Wet buckle packer 100 is configured to automatically respond to water invasion into the inner diameter of the pipeline and rapidly deploy a sealing system that will prevent the laid pipeline from being flooded with sea water, which is described in more detail with reference to FIGS. 4A and 4B.

Hoist line 113 extends from hoist ring 102 up to, for example, a hoist machine on a pipelay vessel. In some examples, packer 100 can include hoist rings on both ends of the device to deploy multiple packers within a pipeline in spaced, series relation within the pipeline. Packer 100 is configured to be arranged within the pipeline such that the end including cap 104 faces the region of the pipeline that is at risk of a wet buckle (or other failure). Thus, in the example of FIG. 1, one packer could be deployed within suspended pipe span 28 closer to the surface than the likely location of the wet buckle in the sagbend of the “S” curve and another packer could be deployed within pipeline 14 on the other side of the likely wet buckle location, e.g., somewhere along sea floor 26.

In this example, the packer deployed closer to the surface would be arranged within suspended pipe span 28 such that perforated cap 104 faces down toward the likely location of the wet buckle in the sagbend. This upper packer could include a hoist line running from the end of the device including base cap 108 and another line running from perforated cap 104 to the lower packer. The lower packer closer to sea floor 26 would be arranged within the pipeline such that cap 104 faces up toward the likely location of the wet buckle in the sagbend and the lower packer would be connected to the upper packer by the line coupled to the perforated caps of each device.

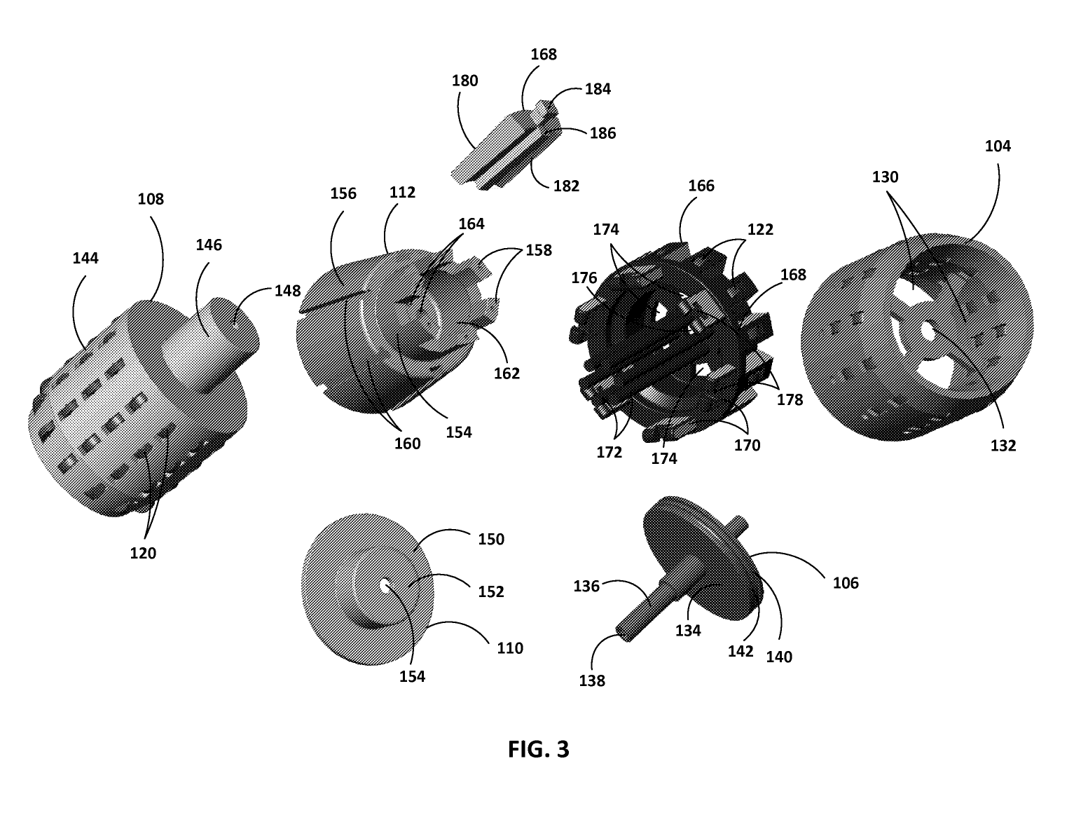

FIG. 3 depicts some components of packer 100 in an exploded view to illustrate the components in greater detail. Perforated cap 104 includes pie-piece shaped perforations 130. The interior of perforated cap 104 is hollow and sized to receive a portion of spindle 106. Perforated end cap 104 also includes central thru hole 132.

Spindle 106 is configured to cause seal plate 110 to axially compress and radially expand expansion boot 114 and to actuate brake assembly 116. Spindle 106 includes end plate 134, central shaft 136, and bore 138. Central shaft 136 protrudes from end plate 134. End plate 134 includes a number of circumferential grooves, including groove 140 and another groove that is configured to receive O-ring 142. O-ring 142 or other similarly functioning seals can be employed to provide a seal between the outer surface of end plate 134 and the inner surface of end cap 104.

Base cap 108 includes a generally cylindrical main body 144 and central shaft 146 extending axially from body 144. Wheels 120 are rotatably coupled to main body 144 of base cap 108. Base cap 108 also includes central thru hole 148 in central shaft 146.

Seal plate 110 includes rim portion 150 and hub portion 152. Additionally, seal plate 110 includes central thru hole 154 in hub 152.

Packer mandrel 112 includes a cylindrical portion 154 and a conical portion 156. Cylindrical portion 154 includes a plurality of axially extending flanges 158. Conical portion 156 includes a tapered outer surface and a plurality of “T” shaped grooves 160, which are inscribed in and distributed evenly around the outer surface of conical portion 156. Packer mandrel 112 also includes bore 162. The base of bore 162 includes a plurality of thru holes 164.

Brake assembly 116 includes brake mandrel 166 and brake pads 168, only one of which is illustrated in FIG. 3. Brake mandrel 166 includes a cup-shaped body 168, a plurality of clevises 170, and a plurality of posts 172. One end of body 168 includes a plurality of apertures 174 and central thru hole 176. Wheels 122 are rotatably connected to body 168. Clevises 170 and posts 172 extend axially from and are connected to body 168. In one example, clevises 170 and/or posts 172 are fabricated separately from and connected to body 168, e.g., by fasteners, welding, or another mechanism. In another example, body 168, clevises 170, and posts 172 are fabricated as a single, integral component. Each of clevises 170 includes a “T” shaped slot 178.

Brake pad 168 includes a curved outer surface 180 and a tapered inner surface 182. Outer surface 180 includes a saw-tooth profile defined by a series of circumferentially extending ridges (see also FIG. 2). Tapered inner surface 182 includes a conical surface that is configured to match and slide along the tapered outer surface of conical portion 156 of packer mandrel 112. Pad 168 also includes “T” shaped tongues 184 and 186. Tongue 184 is configured to be received in grooves 160 in conical portion 156 of packer mandrel 112. Tongue 186 is configured to be received in slot 178 in a clevis 170 of brake mandrel 166.

FIGS. 4A and 4B depict section views of wet buckle packer 100 within pipeline 200. In FIG. 4A, packer 100 is unengaged with pipeline 200. In FIG. 4B, packer 100 is engaged with pipeline 200 to substantially seal the inner diameter of pipeline 200 from water invasion. As illustrated in the section views of FIGS. 4A and 4B, the components of packer 100 are axially aligned along longitudinal axis 202 of packer 100. Packer includes mounting shafts 204 and 206 by which the components of packer 100 are coupled and axially aligned. Mounting shaft 204 is connected to packer mandrel 112 within conical bore 208 and is received in central hole 154 of seal plate and central hole 148 of base cap 108. Mounting shaft 206 is connected to packer mandrel 112 within cylindrical bore 162 and is received in bore 138 of spindle 106. Spindle 106 is arranged and moves axially within end cap 104. Additionally, shaft 136 of spindle 106 is received in central hole 176 of brake mandrel 166.

Mounting shafts 204 and 206 can be connected to packer mandrel 112 by fasteners, welding, or other mechanisms. Additionally, packer mandrel 112 can be fabricated with mounting shafts 204 and 206 integral with the mandrel. The end of mounting shaft 204 opposite the connection with packer mandrel 112 is connected to base cap 108 by, e.g., a threaded connection including a nut as illustrated in FIGS. 4A and 4B or another appropriate mechanism.

End cap 104, base cap 108, and packer mandrel 112 remain in a fixed position relative to other components of packer 100 in both the unengaged and engaged states illustrated in FIGS. 4A and 4B, respectively. Spindle 106, seal plate 110, expansion boot 114, and brake assembly 116, on the other hand, are all configured to change position when packer 100 is actuated.

End cap 104 is connected to one end of packer mandrel 112. Base cap 108 is connected adjacent the opposite end of packer mandrel 112 via mounting shaft 204 connected through hole 148 in shaft 146 of base cap 108.

Seal plate 110 is disposed between packer mandrel 112 and base cap 108. Hub 152 of seal plate 110 receives shaft 146 of base cap 108. Additionally, hub 152 is arranged and axially moveable within conical bore 208 of packer mandrel 112. As noted above, base cap 108, seal plate 110, and packer mandrel 112 are axially aligned by mounting shaft 204.

Expansion boot 114 includes two annular elastomeric boots separated by a spacer 210. Expansion boot 114 includes a central hole, which receives central shaft 146 of base cap 108. Body 144 and shaft 146 of base cap 108 form shoulder 210. Expansion boot 114 is arranged between rim 150 of seal plate 110 and shoulder 210 of base cape 108. Spindle 106 is configured to move axially toward base cap 108. As spindle 106 moves toward base cape 108, spindle 106 causes rim 150 of seal plate 110 to move closer to shoulder 210 of base cap, which compresses expansion boot 114 axially. As expansion boot 114 is compressed axially, boot 114 also radially expands into engagement with an inner surface of pipeline 200.

As noted above, expansion boot 114 includes two annular elastomeric boots separated by spacer 210. However, in other examples, expansion boot 114 can include one or more than two elastomeric elements. Spacer 210 can be a Teflon, brass, rubber, or other appropriate type of spacer element or elements interposed between the elastomeric boots of expansion boot 114. Employing multiple elastomeric boots allows each boot of expansion boot 114 to include different Durometers. Employing multiple boots with multiple, different Durometers can allow packer 100 to be used in a range of different depths and different temperatures.

Brake assembly 116 includes brake mandrel 166 and brake pads 168. Each brake pad includes tapered inner surface 180. Tapered inner surface 180 is configured to match and slide along a tapered outer surface 212 formed by conical portion 156 of packer mandrel 112. Axial and radial translation of brake pads 168 are guided by tapered inner surface 182 of pads 168 and tapered outer surface 212 of packer mandrel 112. Pads 168 can also be generally fixed and located in the circumferential direction by “T” shaped tongues 186, which cooperate with and are received by corresponding “T” shaped grooves 160 in tapered outer surface 212. Grooves 160 are inscribed in outer surface 212 of packer mandrel 120 at different angularly disposed, circumferential positions around longitudinal axis 202 of packer 100.

As spindle 106 moves axially toward base cap 108, shaft 136 of spindle 106 drives brake mandrel 166 axially toward seal plate 110. Axial movement of brake mandrel 166 drives brake pad 168 toward seal plate 110. As brake pad 168 moves axially toward seal plate 110, pad 168 is also driven radially outward by the interaction between tapered inner surface 182 of pad 168 and tapered outer surface 212 of conical portion 156 of packer mandrel 112. To accommodate the radially changing position of brake pad 168 and the radially fixed position of brake mandrel 166, “T” shaped tongue 184 of pad 168 is configured to slide in slot 178 of clevis 170 of brake mandrel 166 as brake assembly 116 is driven axially toward seal plate 110.

As tapered inner surface 182 of pad 168 slides along tapered outer surface 212 of packer mandrel 112 to drive pad 168 radially outward, brake pad 168 is pushed radially outward into engagement with the inner surface of pipeline 200. Outer surface 180 of brake pad 168 includes a saw-tooth profile defined by a series of circumferentially extending ridges, which are configured to engage the inner surface of pipeline 128 without slipping. In many examples, the ridges will not be symmetrical, but will be configured particularly to prevent movement in the direction toward base cap 108 (i.e., away from the likely location of water influx due to a wet buckle). In one example, pad 168 is manufactured from steel and, in some cases, can include carbide buttons that form the saw-tooth profile of pad 168.

Packer 100 is configured to be automatically actuated in the event of a wet buckle of pipeline 200. In such an event, water invades pipeline 200 and flows through the pipe toward end cap 104. Pressure plate 134 of spindle 106 is configured to move axially within cap 104. Pressure plate 134 can be sealed within end cap 104, e.g., by O-ring 142. Additional seals between pressure plate 134 and end cap 104 can also be provided, including, e.g., one or more O-rings received in grooves in the inner surface of end cap 104. Without the application of an external force like the pressure produced by water in pipeline 200, pressure plate 134 is positioned toward the end of end cap 104 to which hoist ring 102 is connected, as illustrated in FIG. 4A. When the wet buckle occurs, water invading pipeline 200 passes through perforations 130 in cap 104 and strikes pressure plate 134 of spindle 106, which moves pressure plate 134 axially base cap 108, i.e. toward the opposite end of packer 100. The surface of pressure plate 134 presents a large surface area against which the water invading pipeline 200 can strike.

As the pressure of the water pushes pressure plate 134 of spindle 106 axially toward base cap 108, central shaft 136 of spindle 106 moves axially drives brake mandrel 166 axially toward seal plate 110. Posts 172 of brake mandrel 166 push seal plate 110. In particular, brake mandrel 166 moves axially toward seal plate 110, which causes brake mandrel 166 to move relative to packer mandrel 112. As brake mandrel 166 moves, flanges 158 of packer mandrel 112 slide through apertures 174 in brake mandrel 166. Additionally, posts 172 slide through holes 164 in packer mandrel 112 and push against hub 152 of seal plate 11. As seal plate 110 moves axially toward base cap 108, rim 150 of seal plate 110 moves axially closer to shoulder 210 of base cap 108, which causes expansion boot 114 to compressed axially between rim 150 and shoulder 210. As expansion boot 114 is compressed axially, boot 114 also radially expands into engagement with an inner surface of pipeline 200. In the radially expanded state illustrated in FIG. 4B, expansion boot 114 is configured to substantially seal pipeline 200 and thereby arrest or mitigate the wet buckle in the pipeline.

In some examples, packer 100 can include an actuator that either augments the effect of the water pressure on pressure plate 134 of spindle 106 or is employed in lieu of automatic actuation by the water pressure. For example, in the event the water pressure fails to actuate the device, packer 100 could include an actuator that drives spindle 106 to seal pipeline 200 and set brake assembly 116. Example actuators that could be employed with packer 100 include a variety of mechanical and electromechanical devices that are configured to be actuated to drive first spindle 106. For example, the actuator can include a pneumatically or hydraulically actuated piston that drives spindle 106 with air or a hydraulic fluid supplied by a supply line connected to packer 100. In another example, the actuator includes an electrically activated solenoid that drives spindle 106. In another example, the actuator includes an electromagnetic piston that drives spindle 106 based on controlled electricity transmitted to packer 100 via the supply line.

In some examples, packer 100 can include a sensor system that detects the invasion of water into the inner diameter of pipeline 200. In another example, the sensor system can be associated with a separate component and be communicatively coupled to packer 100. In one example, the sensor system includes a water sensor including two spaced electrodes arranged within pipeline 200 such that water invading the pipeline would complete an electrical circuit of the sensor. In another example, a pressure sensor could be used to detect the invasion of water into the inner diameter of pipeline 118. The sensor system communicatively coupled to packer 100 can provide a signal directly to control electronics included in an actuator of packer 100 or can transmit signals to a surface system, which, in turn, transmits control signals to an actuator via a supply line. Wet buckle detection via such a sensor system could be employed to test or verify whether packer 100 is actuated and, in some examples, could be used as a trigger to activate an actuator included in packer 100.

In conjunction with axial movement of spindle 106 to cause expansion boot 114 to engage pipeline 200, brake assembly 116 is also deployed to prevent or substantially inhibit movement of packer 100 within pipeline 200. For example, as the pressure of the water strikes pressure plate of spindle 106, central shaft 136 moves brake mandrel 166 axially toward seal plate 110. Brake mandrel 166 drives tapered inner surface 182 of pads 168 along tapered outer surface 212 of packer mandrel 112, which pushes brake pads 168 radially outward into engagement with the inner surface of pipeline 200 to prevent or inhibit packer 100 from moving within the pipeline.

Packer 100 is configured such that in the unengaged state illustrated in FIG. 4A at least some portions of the outer boundaries of packer 100 are offset from the inner surface of pipeline 200. The offset distance between packer 100 and the inner surface of pipeline 200 may differ at different points along the axial length of packer 100. For example, offset 214 between expansion boot 114 and the inner surface of the pipeline 200 is different than offset 216 between brake pads 168 and the inner surface of pipeline 200. The outer periphery of end cap 106, end cap 108, seal plate 110, expansion boot 114, and brake assembly 116 may be configured to fit closely with the inner surface of pipeline 200 even when packer 100 is in an unengaged state. In one example, packer 100 is designed such that offset 214 is less than or equal to ⅛ inch, while offset 216 is greater than ⅛ inch. However, in other examples, offset 214 and offset 216 can be larger or smaller depending on the clearance between packer 100 and pipeline 200 necessary to allow packer 100 to be deployed through pipeline 200 and the amount of radial expansion of expansion boot 114 and brake pads 168 that is provided when spindle 106 moves axially toward base cap 108.

Although particular offset distances are described with reference to example packer 100, a packer in accordance with this disclosure will be constructed with a desired dimensional relationship with the dimensions of the pipeline in which the device is to be used. In one example configuration, a radial clearance of less than or approximately equal to ⅛ inch will separate the sealing element of the packer and the pipeline inner surface and a radial clearance of less than or approximately equal to ¼ inch will separate the braking element of the packer and the pipeline inner surface. However, as will be apparent to persons skilled in the art, difference radial dimensions may be used for any size pipe, and in some cases such dimensions may be determined by other factors, such as the designed radius of bends the pipeline will experience while being installed on the sea floor, and/or the intended characteristic of the internal welds used to join the pipeline sections.

In some cases, it may be desirable to configured packer 100 such that offset 214 between expansion boot 114 and the inner surface of the pipeline 200 is as small as possible while still allowing packer 100 to be deployed downpipe within pipeline 200. In one example, the outer periphery of expansion boot 114 is configured to abut or nearly abut the inner surface of pipeline 200 even in the unengaged state of packer 100, as illustrated in FIG. 4A. In practice, there may be a delay between the occurrence of a wet buckle to pipeline 200 and water striking pressure plate 134 of spindle 106 to cause packer 100 to become engaged with the inner surface of pipeline 200. During the delay in actuation of packer 100 some water may pass through packer 100. Reducing offset 214 between expansion boot 114 and the inner surface of the pipeline 200 will reduce the amount of water that floods pipeline 200 before packer 100 is engaged and expansion boot 114 substantially seals the inner diameter of the pipeline.

As is illustrated in FIG. 4A, end cap 104, base cap 108, and packer mandrel 112 are hollow and seal plate 110 and brake mandrel 166 are relatively thin-walled components. It may be desirable to design the components of packer 100 and other wet buckle packers in accordance with this disclosure in order to reduce the weight of the device. Packer 100 may be employed in relatively large pipelines. In one example, pipeline 200 has an inner diameter that is approximately equal to 40 inches. The large size of pipeline 200 necessitates a relatively large packer to seal the inner diameter of the pipeline. As such, in one example, packer 100 may weigh on the order of thousands of pounds. In such situations, removing as much material from end cap 104, base cap 108, packer mandrel 112, seal plate 110, brake mandrel 166, and other components of packer 100 can have a significant impact on the weight of the device.

The overall weight of packer 100 also affects the amount of load on hoist line 113 and, as a result, the amount of work required by the hoist machine operating hoist line 113. As such, reducing the weight of packer 100 can also reduce the cost and complexity of deploying packer 100 via hoist line 113.

The forces encountered by packer 100 in the event of a wet buckle of pipeline 200 may be significant. For example, at a relatively shallow depth of approximately 1500 feet below sea level, the pressures generated by a wet buckle can reach approximately 660 pounds per square inch (psi). At a depth of approximately 12,000 feet, the pressures generated by a wet buckle can reach approximately 5280 psi. In view of the range of forces potentially encountered by wet buckle packer 100, the wall thicknesses of the components of packer 100 may need to be adjusted to withstand large forces/pressures.

Forces encountered by different portions of packer 100 may differ significantly. For example, portions of packer 100 may be partially or substantially pressure balanced because water introduced into pipeline 200 is allowed to enter parts of packer 100. In such situations, the pressure of the water is balanced on particular portions of packer 100. For example, water may be allowed to enter portions of packer 100 such that the pressure is balanced on either side of a wall of one or more of end cap 104, base cap 108, and packer mandrel 112. In one example, packer mandrel 112 and brake mandrel 166 are configured to be substantially pressure balanced. In some examples, therefore, packer 100 may be designed to allow pressure balancing of some portions of the device such that the wall thicknesses of different portions of end cap 104, base cap 108, packer mandrel 112, brake mandrel 166, and other components of packer 100 may differ significantly depending on the amount of pressure/force encountered in the event of a wet buckle.

A variety of materials can be used to fabricate the components of packer 100 including, e.g., metals, plastics, elastomers, and composites. For example, end cap 104, spindle 106, base cap 108, seal plate 110, packer mandrel 112, brake pads 180, and brake mandrel 166 can be fabricated from a variety of different types of steel or aluminum. Expansion boot 114 and/or brake pads 168 can be fabricated from a variety of elastomeric materials including rubber. In one example, expansion boot(s) 114 are fabricated from a nitrile rubber. At the sea floor, packer 100 may encounter temperatures as low as 32 degrees Fahrenheit (0 degrees Celsius). As such, expansion boot 114 may need to be fabricated from elastomers that can withstand relatively low temperatures without significantly affecting the material properties of disk 108. For example, expansion boot 114 may need to be fabricated from elastomers that can withstand relatively low temperatures without causing boot 114 to become too hard, stiff and/or brittle such that the disks are incapable of sufficiently sealing the inner diameter of pipeline 200. The components of packer 100 can be fabricated using a variety of techniques including, e.g., machining, injection molding, casting, and other appropriate techniques for manufacturing such parts.

Packer 100 may also include a helical coil spring 218 arranged between pressure plate 134 and end cap 104. Spring 218 can be employed to provide a number of functions related to engaging packer 100. Spring 218 can be configured to provide force to assist the engagement of packer 100. For example, spring 218 can be compressed between pressure plate 134 and end cap 104 when packer 100 is in the unengaged state illustrated in FIG. 4A. Pressure plate 134 may be held in position against the force of spring 218 by pins (not shown) received in holes 220 in end cap 104 and engaging slot 140 in pressure plate 134. The pins can be configured such that the force of water invading pipeline 200 shears the pins and releases pressure plate 134. The force generated by spring 218 can push against pressure plate 134 to augment the force of the water pushing pressure plate 134 axially toward base cap 108. Additionally, once engaged as illustrated in FIG. 4B, the axially expanded spring 218 can function resist packer 100 from becoming unengaged and thus lock or partially lock expansion boot 114 and brake assembly 116 in engagement with the inner surface of pipeline 200.

Packer 100 also includes quick-disconnect device 222. In the event packer 100 is deployed to arrest a failure in pipeline 200 it may become necessary to disconnect packer 100 from hoist line 113. In such cases, disconnect device 222 can be employed to disconnect hoist line 113 from packer 100 after the device has been engaged within submerged pipeline 200 to arrest a wet buckle or other type of pipeline failure. Disconnect device 222 includes a collet, at least a portion of which is received within central hole 132 in end cap 104. In the first position of spindle 106 illustrated in FIG. 4A, shaft 136 of spindle 106 engages the collet to lock disconnect device 222 to end cap 104. In the second position, shaft 136 disengages the collet to unlock disconnect device 222 from end cap 104. Examples of quick-disconnect devices that can be employed in conjunction with wet buckle packers in accordance with this disclosure are described and disclosed in U.S. application Ser. No. ______ (Atty. Docket No. 1880.516US1), filed on Jul. ______, 2013, and entitled “METHODS AND APPARATUS FOR ARRESTING FAILURES IN SUBMERGED PIPELINES,” the entire contents of which is incorporated herein by reference.

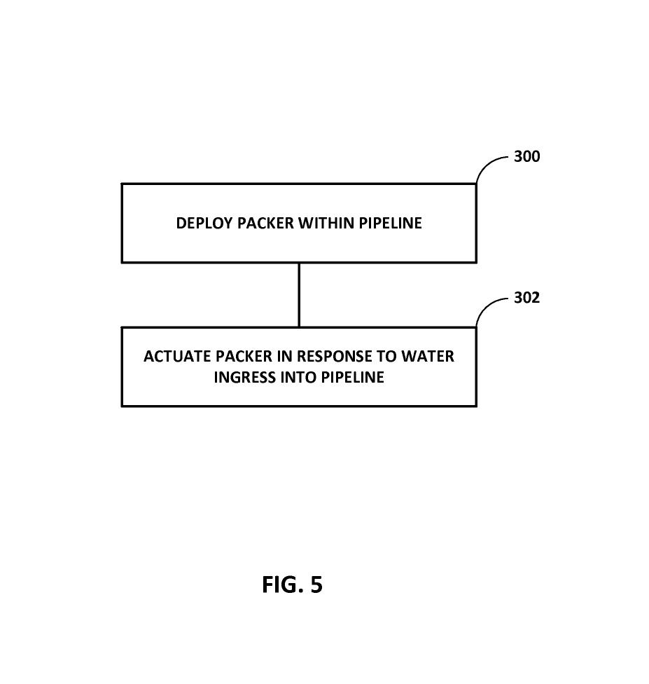

FIG. 5 is a flowchart depicting an example method of arresting a failure of a submerged pipeline. The method includes deploying a packer apparatus within the pipeline (300) and actuating the packer apparatus in response to water ingress into the pipeline (302). The packer apparatus can be deployed into the pipeline via a hoist line connected to a hoist machine on a pipelay vessel. In one example, the packer apparatus that is employed in conjunction with the example method of FIG. 5 is similar to packer 100 described above. As such, in one example, packer 100 employed to carry out the method of FIG. 5 includes spindle 106, base cap 108, seal plate 110, packer mandrel 112, brake assembly 116, and expansion boot 114. Spindle includes pressure plate 134 disposed adjacent a first end of packer 100 including end cap 104. Base cap 108 generally defines the second end of packer 100. Seal plate 110 is disposed between pressure plate 134 and base cap 108. Packer mandrel 112 and brake assembly 114 are disposed between pressure and seal plates 134 and 110, respectively. Packer mandrel 112 includes tapered outer surface 212 and brake assembly 116 includes tapered inner surface 182 abutting the tapered inner surface of the packer mandrel. Elastomeric expansion boot 114 is disposed between seal plate 110 and base cap 108.

Packer 100 is actuated in response to and as a result of water ingress into the pipeline. For example, actuating packer 100 can include moving spindle 106 axially toward base cap 108 from a first position to a second position. Spindle 106 is moved from the first to the second position as a result of fluid pressure generated by the water in the pipeline. The fluid pressure of the water in the pipeline acts to push pressure plate 134 of spindle 106, which drives spindle 106 including central shaft 136 axially toward base cap 108. In the second position, central shaft 136 drives posts 172 of brake mandrel 166 against seal plate 110. Seal plate 110 is moved axially toward shoulder 210 of base cap 108 to axially compress and radially expand expansion boot 114 into engagement with the inner surface of the pipeline. Additionally, in the second position, tapered inner surface 182 of brake assembly 116 is caused to move axially along tapered outer surface 212 of packer mandrel 112 to cause brake assembly 116 to move radially outward into engagement with the inner surface of the pipeline.

As described above, methods of arresting failures of a submerged pipeline can include deploying multiple packers within the submerged pipeline. In one example, the packers are deployed on either side (e.g. one closer to the surface and one farther from the surface and closer to the sea floor) of the likely location of the wet buckle (or other failure). In such examples, both packers can be actuated to seal the region of the pipeline between the packers and including the location of the failure.

As described above, the method of FIG. 5 includes actuation of a packer apparatus in response to and as a result of water ingress into a pipeline. As illustrated by the examples of packer 100, the packer can not only be actuated in response to but also as a result of the water the water in the pipeline. In other words, the packer actuation is automatically caused by fluid pressure generated by the water invading the pipeline. Thus, the example method of FIG. 5 can be carried out with any packer apparatus that is configured to be automatically actuated by fluid pressure within a pipeline. Additional examples of such apparatus are disclosed and described in U.S. application Ser. No. ______ (Atty. Docket No. 1880.517US1), filed on Jul. ______, 2013, U.S. application Ser. No. ______ (Atty. Docket No. 1880.523US1), filed on Jul. ______, 2013, and U.S. application Ser. No. ______ (Atty. Docket No. 1880.563US1), filed on Jul. ______, 2013, all of which are entitled “METHODS AND APPARATUS FOR ARRESTING FAILURES IN SUBMERGED PIPELINES,” and the entire contents of all of which are incorporated herein by reference.

Various examples have been described. These and other examples are within the scope of the following claims.

I claim:

1. A packer apparatus configured to be arranged within and arrest a failure of a submerged pipeline, the packer apparatus comprising:
a spindle comprising a pressure plate disposed adjacent a first end of the packer apparatus;
a first end cap defining the second end of the packer apparatus;
a seal plate disposed between the pressure plate and the first end cap;
a mandrel and a brake disposed between the pressure and seal plates, wherein the mandrel comprises a tapered outer surface and the brake comprises a tapered inner surface abutting the tapered inner surface of the mandrel; and
an elastomeric expansion boot disposed between the seal plate and the first end cap,
wherein the pressure plate is configured to be actuated by fluid pressure within the pipeline to move the spindle axially toward the first end cap from a first position to a second position, and
wherein, in the second position, the spindle causes:
the expansion boot to compress axially between the seal plate and the first end cap and expand radially into engagement with an inner surface of the pipeline; and
the tapered inner surface of the brake to move axially along the tapered outer surface of the mandrel to cause the brake to move radially outward into engagement with the inner surface of the pipeline.

2. The apparatus of claim 1, further comprising a second end cap within which the pressure plate of the spindle is received, and wherein apertures in the second end cap are configured to allow a pressurized fluid to pass through the second end cap to apply pressure to the pressure plate to move the spindle axially toward the first end cap from the first position to the second position.

3. The apparatus of claim 2, wherein at least one of the first end cap, the second end cap, and the brake comprises a plurality of wheels rotatably connected to the at least one of the first end cap, the second end cap, and the brake.

4. The apparatus of claim 1, wherein, in the first position of the spindle, the expansion boot is in a radially unexpanded state and the brake is unengaged with the inner surface of the pipeline.

5. The apparatus of claim 1, wherein the mandrel comprises a conical portion defining the tapered outer surface.

6. The apparatus of claim 5, wherein the mandrel comprises a first mandrel and the brake comprises:
a second mandrel comprising at least one post and a plurality of clevises, wherein the second mandrel is configured to move axially relative to the first mandrel;
a plurality of pads, each of which comprises a tapered inner surface abutting the tapered outer surface of the mandrel,
wherein each pad is connected to a respective one of the clevises, and wherein the pads and the clevises are distributed at different angularly disposed, circumferential positions around a longitudinal axis of the packer apparatus.

7. The apparatus of claim 6, wherein each of the pads comprises a curved outer surface that substantially matches a curved inner surface of the pipeline.

8. The apparatus of claim 7, wherein the curved outer surface of each of the pads comprises a saw-tooth profile defined by a series of circumferentially extending ridges.

9. The apparatus of claim 6, wherein:
the spindle comprises a first shaft comprising a shoulder;
a portion of the first shaft is received in a hole in the second mandrel and the shoulder is configured to engage the second mandrel;
the pressure plate is configured to be actuated by fluid pressure within the pipeline to cause the shoulder to move the second mandrel from a first position to a second position; and
in the second position of the second mandrel, the at least one post causes:
the seal plate to compress the expansion boot axially between the seal plate and the first end cap, which causes the expansion boot to expand radially into engagement with an inner surface of the pipeline.

10. The apparatus of claim 9, wherein:
the first end cap comprises a shoulder formed by a cylindrical body comprising a first diameter and a second shaft extending axially from the body and comprising a second diameter that is smaller than the first diameter; and
in the second position of the second mandrel, the at least one post causes:
the seal plate to compress the expansion boot axially between the seal plate and the shoulder of the first end cap, which causes the expansion boot to expand radially into engagement with an inner surface of the pipeline.

11. The apparatus of claim 10, wherein the expansion boot is circumferentially disposed around the second shaft of the first end cap.

12. The apparatus of claim 10, wherein the seal plate comprises:
a central hub portion; and
a rim portion extending radially outward from the hub portion,
wherein the second shaft of the first end cap is at least partially received in the hub portion, and
wherein, in the second position of the second mandrel, the at least one post causes:
the seal plate to compress the expansion boot axially between the rim portion of the seal plate and the shoulder of the first end cap, which causes the expansion boot to expand radially into engagement with an inner surface of the pipeline.

13. A system for arresting a failure of a submerged pipeline, the system comprising:
a hoist machine;
a packer apparatus configured to be arranged within the submerged pipeline, wherein the packer apparatus comprises:
a spindle comprising a pressure plate disposed adjacent a first end of the packer apparatus;
a first end cap defining the second end of the packer apparatus;
a seal plate disposed between the pressure plate and the first end cap;
a mandrel and a brake disposed between the pressure and seal plates, wherein the mandrel comprises a tapered outer surface and the brake comprises a tapered inner surface abutting the tapered inner surface of the mandrel; and
an elastomeric expansion boot disposed between the seal plate and the first end cap,
wherein the pressure plate is configured to be actuated by fluid pressure within the pipeline to move the spindle axially toward the first end cap from a first position to a second position, and
wherein, in the second position, the spindle causes:
the expansion boot to compress axially between the seal plate and the first end cap and expand radially into engagement with an inner surface of the pipeline; and
the tapered inner surface of the brake to move axially along the tapered outer surface of the mandrel to cause the brake to move radially outward into engagement with the inner surface of the pipeline; and
a hoist line comprising a first end operatively connected to the hoist machine and a second end connected to the packer apparatus.

14. The system of claim 13, wherein the packer apparatus comprises a second end cap within which the pressure plate of the spindle is received, and wherein apertures in the second end cap are configured to allow a pressurized fluid to pass through the second end cap to apply pressure to the pressure plate to move the spindle axially toward the first end cap from the first position to the second position.

15. The system of claim 14, wherein at least one of the first end cap, the second end cap, and the brake comprises a plurality of wheels rotatably connected to the at least one of the first end cap, the second end cap, and the brake.

16. The system of claim 13, wherein, in the first position of the spindle, the expansion boot is in a radially unexpanded state and the brake is unengaged with the inner surface of the pipeline.

17. The system of claim 13, wherein the mandrel comprises a conical portion defining the tapered outer surface.

18. The system of claim 17, wherein the mandrel comprises a first mandrel and the brake comprises:
a second mandrel comprising at least one post and a plurality of clevises, wherein the second mandrel is configured to move axially relative to the first mandrel;
a plurality of pads, each of which comprises a tapered inner surface abutting the tapered outer surface of the mandrel,
wherein each pad is connected to a respective one of the clevises, and wherein the pads and the clevises are distributed at different angularly disposed, circumferential positions around a longitudinal axis of the packer apparatus.

19. The system of claim 18, wherein each of the pads comprises a curved outer surface that substantially matches a curved inner surface of the pipeline.

20. The system of claim 19, wherein the curved outer surface of each of the pads comprises a saw-tooth profile defined by a series of circumferentially extending ridges.

21. The system of claim 18, wherein:
the spindle comprises a first shaft comprising a shoulder;
a portion of the first shaft is received in a hole in the second mandrel and the shoulder is configured to engage the second mandrel;
the pressure plate is configured to be actuated by fluid pressure within the pipeline to cause the shoulder to move the second mandrel from a first position to a second position; and
in the second position of the second mandrel, the at least one post causes:
the seal plate to compress the expansion boot axially between the seal plate and the first end cap, which causes the expansion boot to expand radially into engagement with an inner surface of the pipeline.

22. The system of claim 21, wherein:
the first end cap comprises a shoulder formed by a cylindrical body comprising a first diameter and a second shaft extending axially from the body and comprising a second diameter that is smaller than the first diameter; and
in the second position of the second mandrel, the at least one post causes:
the seal plate to compress the expansion boot axially between the seal plate and the shoulder of the first end cap, which causes the expansion boot to expand radially into engagement with an inner surface of the pipeline.

23. The system of claim 22, wherein the expansion boot is circumferentially disposed around the second shaft of the first end cap.

24. The system of claim 22, wherein the seal plate comprises:
a central hub portion; and
a rim portion extending radially outward from the hub portion,
wherein the second shaft of the first end cap is at least partially received in the hub portion, and
wherein, in the second position of the second mandrel, the at least one post causes:
the seal plate to compress the expansion boot axially between the rim portion of the seal plate and the shoulder of the first end cap, which causes the expansion boot to expand radially into engagement with an inner surface of the pipeline.

25. A system for arresting a failure of a submerged pipeline, the system comprising:
a first packer apparatus configured to be disposed at a first position within the pipeline; and
a second packer apparatus configured to be disposed at a second position within the pipeline,
wherein at least one of the first and the second packer apparatus comprises:
a spindle comprising a pressure plate disposed adjacent a first end of the packer apparatus;
a first end cap defining the second end of the packer apparatus;
a seal plate disposed between the pressure plate and the first end cap;
a mandrel and a brake disposed between the pressure and seal plates, wherein the mandrel comprises a tapered outer surface and the brake comprises a tapered inner surface abutting the tapered inner surface of the mandrel; and
an elastomeric expansion boot disposed between the seal plate and the first end cap,
wherein the pressure plate is configured to be actuated by fluid pressure within the pipeline to move the spindle axially toward the first end cap from a first position to a second position, and
wherein, in the second position, the spindle causes:
the expansion boot to compress axially between the seal plate and the first end cap and expand radially into engagement with an inner surface of the pipeline; and
the tapered inner surface of the brake to move axially along the tapered outer surface of the mandrel to cause the brake to move radially outward into engagement with the inner surface of the pipeline.

26. A method of arresting a failure of a submerged pipeline, the method comprising:
deploying a packer apparatus within the pipeline, wherein the packer apparatus comprises:
a spindle comprising a pressure plate disposed adjacent a first end of the packer apparatus;
a first end cap defining the second end of the packer apparatus;
a seal plate disposed between the pressure plate and the first end cap;
a mandrel and a brake disposed between the pressure and seal plates, wherein the mandrel comprises a tapered outer surface and the brake comprises a tapered inner surface abutting the tapered inner surface of the mandrel; and
an elastomeric expansion boot disposed between the seal plate and the first end cap;
actuating the packer apparatus in response to water ingress into the pipeline,
wherein actuating the packer apparatus comprises engaging the pressure plate with the water in the pipeline to move the spindle axially toward the first end cap from a first position to a second position, and
wherein, in the second position, the spindle causes:
the expansion boot to compress axially between the seal plate and the first end cap and expand radially into engagement with an inner surface of the pipeline; and
the tapered inner surface of the brake to move axially along the tapered outer surface of the mandrel to cause the brake to move radially outward into engagement with the inner surface of the pipeline.
